(19) United States
(12) Patent Application Publication
(10) Pub. No.: US 2025/0032335 A1
(43) Pub. Date: Jan. 30, 2025

(54) Patient Support System And Apparatus For Use With A Bariatric Patient

(71) Applicant: Stryker Corporation, Kalamazoo, MI (US)

(72) Inventors: Mackenzie Van Loon, Mattawan, MI (US); Brandon David Naber, Portage, MI (US); Neil Feliksa, Kalamazoo, MI (US)

(73) Assignee: Stryker Corporation, Kalamazoo, MI (US)

(21) Appl. No.: 18/783,561

(22) Filed: Jul. 25, 2024

Related U.S. Application Data
(60) Provisional application No. 63/528,733, filed on Jul. 25, 2023.

(51) Int. Cl. A61G 7/10; A61G 1/02; A61G 3/08

(52) U.S. Cl. CPC A61G 7/1019; A61G 1/0287; A61G 3/0875; A61G 2210/00

(57) ABSTRACT

A patient transport system for use with a bariatric patient includes a patient transport apparatus and a plurality of flexible caregiver interfaces. The patient transport apparatus may include a litter frame and at least three jacks operatively attached to the litter frame for moving the patient transport apparatus between a plurality of vertical configurations relative to a floor surface. The plurality of flexible caregiver interfaces each include a coupling end operatively attached to the patient transport apparatus and an interface end. The plurality of flexible caregiver interfaces also each define a respective plurality of grab points arranged to be grasped by one of a plurality of caregivers positioned around lateral sides of the patient transport apparatus for applying lifting force to lift the patient transport apparatus and the bariatric patient.

### CROSS-REFERENCE TO RELATED APPLICATION

The subject patent application claims priority to and all the benefits of U.S. Provisional Patent Application No. 63/528,733 filed on Jul. 25, 2023, the disclosure of which is hereby incorporated by reference in its entirety.

### BACKGROUND

Bariatric patients present unique challenges in relation to patient transport apparatuses. Particularly, lifting these patients relative to a floor surface requires stronger lifting mechanisms and/or significant physical effort that often involves multiple caregivers, leading to potential safety risks and injuries. Additionally, maintaining stability of patient transport apparatuses during transportation becomes more challenging due to the higher center of gravity and altered mass distribution of bariatric individuals. Furthermore, locating and securing bariatric patients on traditional patient transport apparatuses can be difficult, as their varying body shapes and sizes may not be adequately accommodated.

Therefore, there is a need in the art for patient transport systems and apparatuses for use with bariatric patients that address one or more of these challenges.

### SUMMARY

One general aspect of the present disclosure includes a patient transport apparatus for use with a bariatric patient. The patient transport apparatus includes a litter frame including a patient support deck for supporting the bariatric patient. The litter frame defines a longitudinal axis extending between a head end and a foot end and a lateral axis transverse to the longitudinal axis. The patient transport apparatus also includes a plurality of wheels coupled to the litter frame for supporting movement of the patient transport apparatus over a floor surface. The patient transport apparatus further includes at least three jacks coupled to the litter frame to move the litter frame and the plurality of wheels between a plurality of vertical configurations relative to the floor surface. Each of the at least three jacks includes a mounting portion coupled to the litter frame, and a foot operatively attached to the mounting portion and configured for movement relative to the mounting portion to provide a respective contact point with the floor surface. At least one of the at least three jacks is arranged between the head end and the lateral axis, at least one of the at least three jacks is arranged between the foot end and the lateral axis, at least one of the at least three jacks is arranged on a first lateral side of the longitudinal axis, and at least one of the at least three jacks is arranged on a second lateral side of the longitudinal axis, opposite the first lateral side.

Another general aspect of the present disclosure includes a patient transport apparatus for use with a bariatric patient. The patient transport apparatus includes a litter frame including a patient support deck for supporting the bariatric patient. The patient transport apparatus also includes a plurality of wheels coupled to the litter frame for supporting movement of the patient transport apparatus over a floor surface. The patient transport apparatus further includes at least one jack coupled to the litter frame to move the litter frame and the plurality of wheels between a plurality of vertical configurations relative to the floor surface. Each jack includes a mounting portion coupled to the litter frame, and a foot operatively attached to the mounting portion and configured for movement relative to the mounting portion to provide a respective contact point with the floor surface. The plurality of vertical configurations includes a lifted configuration where the foot of each jack is moved away from the litter frame such that the plurality of wheels are spaced out of contact with the floor surface and the at least one jack supports the patient transport apparatus relative to the floor surface.

Yet another general aspect of the present disclosure includes a patient transport system for use with a bariatric patient. The patient transport system includes a patient transport apparatus including a support structure including a patient support deck for supporting the bariatric patient. The patient transport system also includes a plurality of flexible caregiver interfaces arranged for respective use by a plurality of caregivers. Each of the plurality of flexible caregiver interfaces includes a coupling end operatively attached to the support structure and an interface end. Additionally, the plurality of flexible caregiver interfaces each define a respective plurality of grab points arranged to be grasped by one of the plurality of caregivers positioned around lateral sides of the patient transport apparatus for applying lifting force to lift the patient transport apparatus and the bariatric patient. Each of the plurality of flexible caregiver interfaces are configured for movement between a stowed configuration and a deployed configuration. In the stowed configuration, the interface end of the flexible caregiver interface is secured adjacent to the support structure. In the deployed configuration, the interface end of the flexible caregiver interface is spaced from the support structure to arrange the plurality of grab points for engagement by one of the respective plurality of caregivers for applying lifting force to lift the patient transport apparatus and the bariatric patient.

### BRIEF DESCRIPTION OF THE DRAWINGS

FIG. 1 is a perspective view of a patient transport apparatus including a litter frame and at least three jacks operatively attached to the litter frame and arranged in a spaced configuration.

FIG. 2 is a perspective view of a patient transport apparatus including at least three jacks arranged in a stabilization configuration.

FIG. 3 is a perspective view of a patient transport apparatus including at least three jacks arranged in a lifted configuration.

FIG. 4 is a partial perspective view of a patient transport apparatus illustrating a jack moving between a deployed configuration and a stored configuration relative to a patient transport apparatus.

FIG. 5 is a partial perspective view of a patient transport apparatus illustrating a jack moving between a stored configuration and a handle configuration relative to a patient transport apparatus.

FIG. 6 is a top view of a patient transport apparatus illustrating one arrangement of at least three jacks relative to a litter frame of the patient transport apparatus.

FIG. 7A is a perspective view of a patient transport apparatus illustrating at least three jacks in a lifted configuration to support the patient transport apparatus relative to an uneven floor surface.

FIG. 7B is another perspective view of a patient transport apparatus illustrating at least three jacks having hydraulic actuators and arranged in a lifted configuration to support the patient transport apparatus relative to an uneven floor surface.

FIG. 8 is a perspective view of a patient transport apparatus in a lifted configuration and defining an access area below a litter frame of the patient transport apparatus that is shaped to receive an auxiliary transport device.

FIG. 9 is a perspective view of the patient transport apparatus of FIG. 8 being lowered by the at least three jacks onto the auxiliary transport device.

FIG. 10 is a perspective view of a patient transport apparatus where a locking feature of a foot of each of at least three jacks is engaged with a corresponding locking feature on an ambulance floor to constrain the patient transport apparatus relative to the ambulance floor.

FIG. 11 is a cross-section representation of a foot of a patient transport apparatus engaged with a corresponding locking feature on an ambulance floor.

FIG. 12 is a top view of a patient transport system including a patient transport apparatus and a plurality of flexible caregiver interfaces operatively attached to the patient transport apparatus.

FIG. 13 is a top view of a patient transport system where a plurality of flexible caregiver interfaces are spaced from a patient transport apparatus.

FIG. 14 is a perspective view of a patient transport system where a plurality of caregivers are positioned around lateral sides of a patient transport apparatus and engaging respective flexible caregiver interfaces to apply lifting force to lift the patient transport apparatus and the bariatric patient.

FIG. 15 illustrates a sequence of moving a flexible caregiver interface from a deployed configuration to a stowed configuration.

FIG. 16 is a top view of a patient transport system where a plurality of flexible caregiver interfaces are in a stowed configuration.

FIG. 17A is a perspective view of a patient transport system where a plurality of flexible caregiver interfaces extend around a bariatric patient such that each of the plurality of flexible caregiver interfaces is configured to engage the bariatric patient to locate and secure the bariatric patient relative to a patient support deck.

FIG. 17B is a perspective view of a patient transport system where a coupler disposed on a first flexible caregiver interface is engaged with a corresponding receiver disposed on a second flexible caregiver interface to locate and secure the bariatric patient relative to a patient support deck.

### DETAILED DESCRIPTION

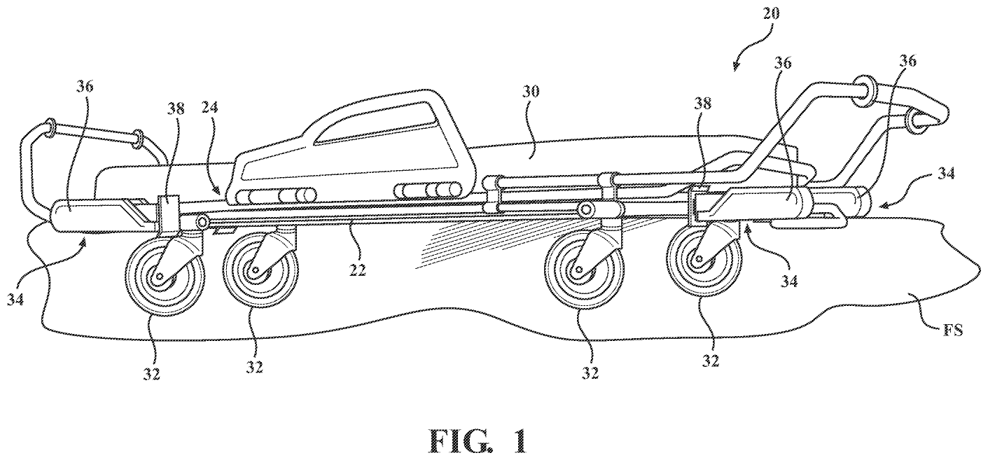

Referring to FIGS. 1-11, a patient transport apparatus 20 is shown. In the representative versions of the present disclosure, the patient transport apparatus 20, as well as other components and systems illustrated throughout the drawings and described herein, are configured for use in facilitating the care and transport of bariatric patients. More specifically, and as will be appreciated from the subsequent description below, the present disclosure affords significant advantages in connection with the care and treatment of relatively heavy patients by, among other things, promoting safe and stable transport under a number of different operating conditions.

Those having ordinary skill in the art will appreciate that the term “bariatric patient” may be defined in various ways, such as for example based on a specific body mass index BMI or weight threshold (e.g., patient weight above 500 lbs, patient weight above 700 lbs, and the like), based on patient conditions and/or body types, sizes, weights, and/or shapes which make unassisted patient movement difficult or which necessitate caregiver-assisted movement, and/or in other ways. In addition to affording advantages in connection with transporting bariatric patients, the patient transport apparatus 20 may also be used to facilitate concurrent transport of the patient and relatively heavy medical devices or equipment used in connection with patient care (not shown). For example, the patient transport apparatus 20 may be utilized in connection with transporting an incubator which, in turn, supports a patient. As will be appreciated from the subsequent description below, the patient transport apparatus 20 and other components and systems described herein may be used in connection with transport and care of any suitable patient and irrespective of the weight of the patient. Accordingly, the term “bariatric patient” is not intended to limit the present disclosure to any particular weight, and may be used interchangeably with the term “patient”.

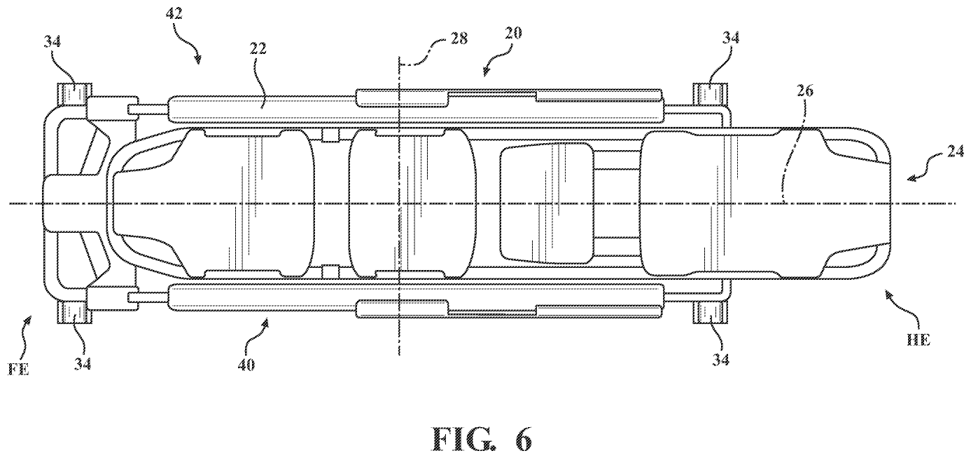

The patient transport apparatus 20 includes a litter frame 22 including a patient support deck 24 for supporting a bariatric patient. As best shown in FIG. 6, the litter frame 22 defines a longitudinal axis 26 extending between a head end HE and a foot end FE to bisect the litter frame 22 longitudinally and a lateral axis 28 transverse to the longitudinal axis 26 to bisect the litter frame 22 laterally. The patient support deck 24 may be defined by one or more articulable deck sections, for example, a back section, a seat section, and a foot section, to facilitate care and/or transportation of the patient in various patient positions. A mattress 30 may be disposed on the patient support deck 24.

The patient transport apparatus 20 also includes a plurality of wheels 32 coupled to the litter frame 22 for supporting movement of the patient transport apparatus over a floor surface FS. Advantageously, because the plurality of wheels 32 are coupled directly to the litter frame 22, intermediate components are eliminated and the center of gravity of the patient transport apparatus 20 is consequently lowered, thereby reducing the risk of the patient transport apparatus 20 tipping when a bariatric patient is disposed on the patient support deck 24. The plurality of wheels 32 may be a plurality of caster assemblies. The caster assemblies may be configured to swivel to facilitate turning of the patient transport apparatus 20. The caster assemblies may include a swivel locking mechanism to prevent the plurality of wheels 32 from swiveling when engaged. The caster assemblies may also include wheel brakes to prevent rotation of the plurality of wheels 32.

In some examples, the patient transport apparatus 20 includes at least one jack 34 coupled to the litter frame 22 to move the litter frame 22 and the plurality of wheels 32 between a plurality of vertical configurations relative to the floor surface FS. In some versions, other quantities of jacks 34 may be employed. For example, at least two jacks 34, at least three jacks 34, more than three jacks 34, and the like. In the representative version depicted throughout the drawings, four jacks 34 are employed. other configurations are contemplated.” Each of the jack(s) 34 includes a mounting portion 36 coupled to the litter frame 22 and a foot 38 operatively attached to the mounting portion 36 and configured for movement relative to the mounting portion 36 to provide a respective contact point with the floor surface FS.

In some configurations, the patient transport apparatus 20 further includes at least three jacks 34 coupled to the litter frame 22 to move the litter frame 22 and the plurality of wheels 32 between a plurality of vertical configurations relative to the floor surface FS. The at least three jacks 34 are arranged about the litter frame 22 such that the at least three jacks are configured to stably support the litter frame 22 above the floor surface FS. Accordingly, at least one of the jack(s) 34 is arranged between the head end HE and the lateral axis 28, at least one of the jack(s) 34 is arranged between the foot end FE and the lateral axis 28, at least one of the at least three jacks is arranged on a first lateral side 40 of the longitudinal axis 26, and at least one of the at least three jacks is arranged on a second lateral side 42 of the longitudinal axis 26, opposite the first lateral side 40. The examples of FIGS. 1-11 show four jacks 34 arranged at the corners of the litter frame 22, but other configurations are contemplated.

FIGS. 1-3 illustrate examples of the plurality of vertical configurations of the litter frame 22 and the plurality of wheels 32 relative to the floor surface FS. Referring to FIG. 1, the plurality of vertical configurations may include a spaced configuration where each foot 38 of the jack(s) 34 are spaced out of contact with the floor surface FS such that the plurality of wheels 32 support movement of the patient transport apparatus 20 over the floor surface FS. Thus, in the spaced configuration, the plurality of wheels 32 support the litter frame 22 above the floor surface FS such that the patient transport apparatus 20 may be moved about the floor surface while rolling on the plurality of wheels 32.

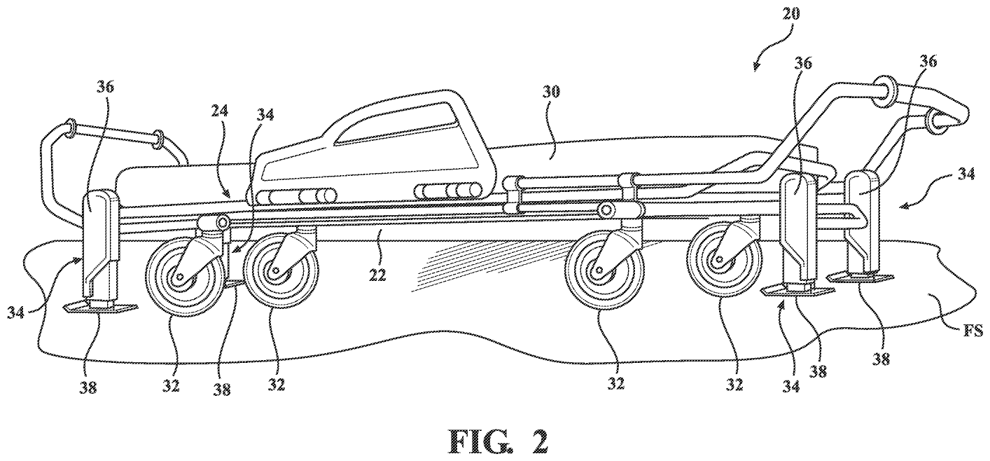

Referring to FIG. 2, the plurality of vertical configurations may also include a stabilization configuration where the plurality of wheels 32 remain in contact with the floor surface FS and each foot 38 of the jack(s) 34 contacts the floor surface FS to provide additional stability to the patient transport apparatus 20. Thus, in the stabilization configuration, the jack(s) 34 are deployed to contact the floor surface FS to provide additional stability to the patient transport apparatus 20. This additional stabilization is advantageous in situations where the patient transport apparatus may be prone to tipping, such as when loading the bariatric patient onto the patient support deck 24. In some configurations, the jack(s) 34 may be arranged more laterally than the plurality of wheels 32, thereby increasing the footprint of the patient transport apparatus 20 to increase stability.

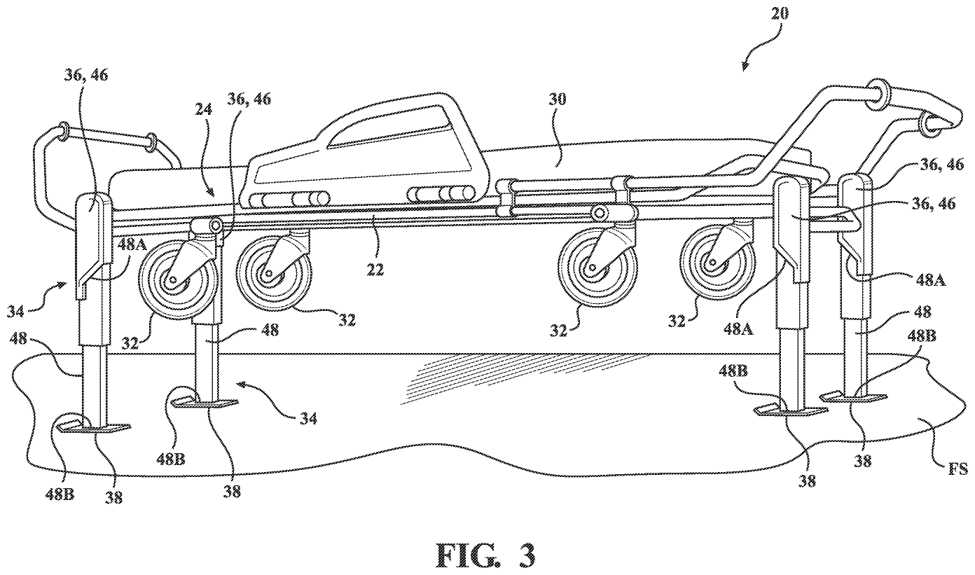

Referring to FIG. 3, the plurality of vertical configurations may further include a lifted configuration where each foot 38 of the jack(s) 34 are moved away from the litter frame 22 such that the plurality of wheels 32 are spaced out of contact with the floor surface FS and the jack(s) 34 support the patient transport apparatus 20 relative to the floor surface FS. The lifted configuration may enable caregivers to elevate the bariatric patient relative to the floor surface FS for a variety of situations for transporting or providing care to a bariatric patient such as helping to lift the bariatric patient off the floor surface, lateral transfer of the bariatric patient to/from another patient transport apparatus, and transfer of the bariatric patient into/out of an ambulance.

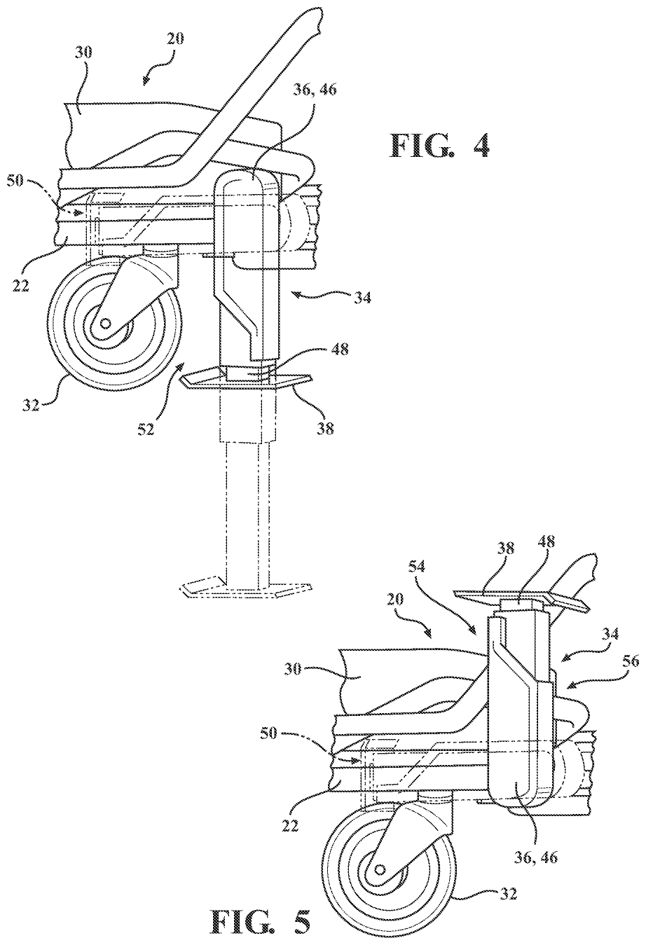

It should be appreciated that a variety of configurations of the jack(s) 34 for moving the foot 38 relative to the mounting portion 36 are contemplated. For example, the jack(s) 34 may be configured as column jacks, scissor jacks, inflatable jacks, and the like. It is also contemplated that the jack(s) 34 may all be the same configuration or have different configurations. In one configuration, referring to FIGS. 4 and 5, mounting portion 36 of each of the jack(s) 34 is realized as a housing 46, and each of the jack(s) 34 further includes a post 48 disposed in the housing 46 for movement relative to the housing 46. The post may extend between a top end 48A and a bottom end 48B, and each foot 38 may be coupled to the bottom end 48B of a respective post 48.

With continued reference to FIGS. 4 and 5, in some examples, the housing 46 of each of the jack(s) 34 may be pivotably coupled to the litter frame 22 such that each of the jack(s) 34 are configured for pivotal movement relative to the litter frame 22 between a plurality of jack configurations. Referring to FIGS. 4 and 5, the plurality of jack configurations may include a stored configuration 50 where the respective post 48 is parallel with the litter frame 22. As shown in FIG. 4, the plurality of jack configurations may also include a deployed configuration 52 where the respective post 48 is arranged extending toward the floor surface FS such that each foot 38 is configured to move relative to the housing 46 (as shown in phantom) to provide a respective contact point with the floor surface FS. Referring now to FIG. 5, the plurality of jack configurations may further include a handle configuration 54 where the respective post 48 is arranged extending away from the floor surface FS such that the respective post 48 provides a grab point 56 arranged for engagement by a caregiver to maneuver the patient transport apparatus 20 across the floor surface FS.

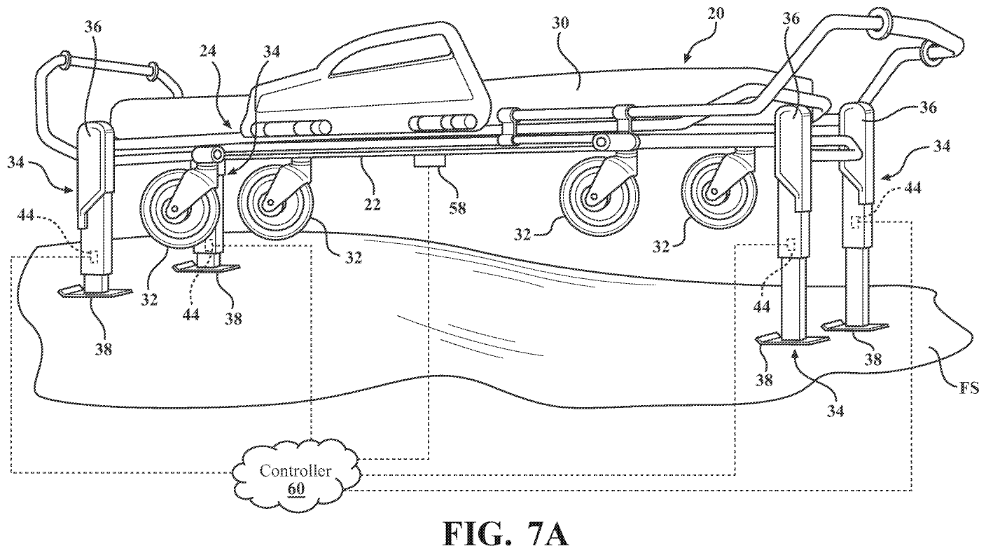

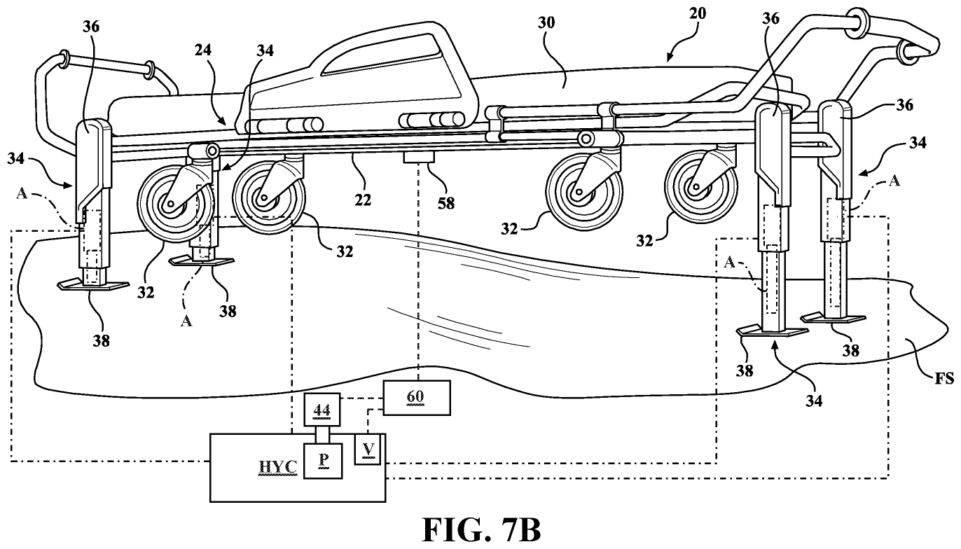

Each of the jack(s) 34 may be unpowered or powered to move the foot 38 relative to the mounting portion 36 to move the litter frame 22 and the plurality of wheels 32 between the plurality of vertical configurations relative to the floor surface FS. As one example, where the jack(s) 34 are unpowered (i.e., manually actuated), each jack 34 may include a manual actuator such as a hand crank operatively attached to the foot 38 and configured to be engaged by a caregiver to move each foot 38 vertically relative to its respective mounting portion 36. Of course, other configurations such as foot pumps, levers, and the like are contemplated. In other examples, where the jack(s) 34 are powered, each of the jack(s) 34 may further include a motor 44 (shown schematically in FIG. 7A) operatively attached to the foot 38 for moving the foot 38 relative to the mounting portion 36 to move the litter frame 22 and the plurality of wheels 32 between the plurality of vertical configurations relative to the floor surface FS. For example, in the configuration of FIGS. 4 and 5 described above, the motor 44 may be operatively attached to the post 48 to move the post 48 (and thus, the foot 38) relative to relative to the housing 46 to move the litter frame 22 and the plurality of wheels 32 between the plurality of vertical configurations relative to the floor surface FS. A variety of configurations for operatively attaching the motor 44 to the foot 38 are contemplated such as a rack and pinion mechanism, a lead screw mechanism, and the like. It is also contemplated that the jack(s) 34 may be hydraulic or pneumatic.

As best shown in FIGS. 7A-7B, to facilitate movement of the patient transport apparatus 20 between the plurality of vertical configurations, each foot 38 of the jack(s) 34 may be configured for independent movement relative to its respective mounting portion 36 to provide a respective contact point with the floor surface FS. The independent movement of each foot 38 is particularly advantageous where the floor surface FS is uneven because the position of each foot 38 may be adjusted to ensure that the litter frame 22 is level. In examples where the jack(s) 34 are powered, such as illustrated in FIG. 7A, the patient transport apparatus 20 may further include a level sensor 58 operatively attached to the litter frame 22 and configured to generate a level signal pertaining to the orientation of the litter frame 22. The patient transport apparatus 20 may further include a controller 60 in communication with the level sensor 58 and each motor 44 of the jack(s) 34. The controller 60 may be configured to operate each motor 44 of the jack(s) 34 to level the litter frame 22 relative to the floor surface FS. However, in some versions, the jacks 34 may be operated, either manually and/or by the controller 60, to facilitate placing the litter frame 22 at an angle relative to the floor surface FS (not shown) such as to place the patient transport apparatus 20 into a Trendelenburg or reverse Trendelenburg configuration, into a lateral tilt configuration such as for facilitating ingress or egress, and the like. Other configurations are contemplated.

Referring to FIG. 7B, in some versions, the jack(s) 34 may employ respective hydraulic actuators A disposed in fluid communication with a hydraulic circuit HYC having a pump P driven by a motor 44 operated by the controller 60. Here, as is depicted schematically, the hydraulic circuit HYC may include one or more valves V operated by the controller 60 to facilitate the flow of hydraulic fluid into and/or out of the hydraulic actuators A to adjust the jack(s) 34. Here too in this version, the jack(s) 34 may be independently movable. In some versions, the controller 60 may be configured to operate the pump P, one or more valves V, and/or other components of the hydraulic circuit HYC to allow each jack 34 to lower into respective contact with the floor surface FS. In some versions, the hydraulic circuit HYC may be configured without the use of the controller 60 and/or motor 44, such as with an arrangement of one or more manually-actuated valves V to facilitate independent operation of the hydraulic actuators A. Here, in some versions, manually-actuated hydraulic actuators A could be disposed in fluid communication with each other at least partially across a common hydraulic circuit HYC, such as to facilitate balancing the actuators A. In some versions, aspects of the jack(s) 34, the hydraulic actuator(s) A, or other components of the patient transport apparatus 20 may be similar to as is described in U.S. Pat. No. 11,730,652 entitled “Patient Support Apparatus With Powered Unloading Dynamic Weigh Adjustment” and/or in U.S. Pat. No. 11,730,650 entitled “Patient Support Apparatus With Hydraulic Oscillation Dampening,” the disclosures of each of which are hereby incorporated by reference in their entirety.

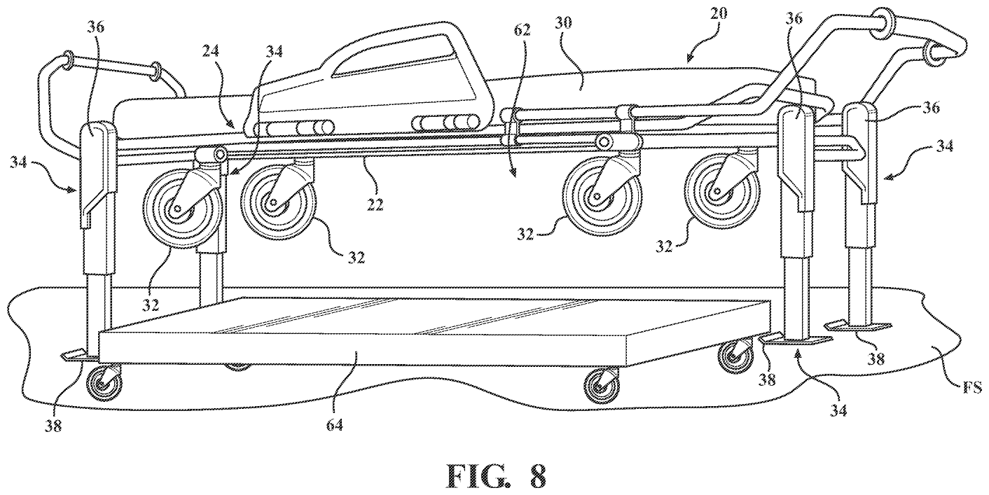

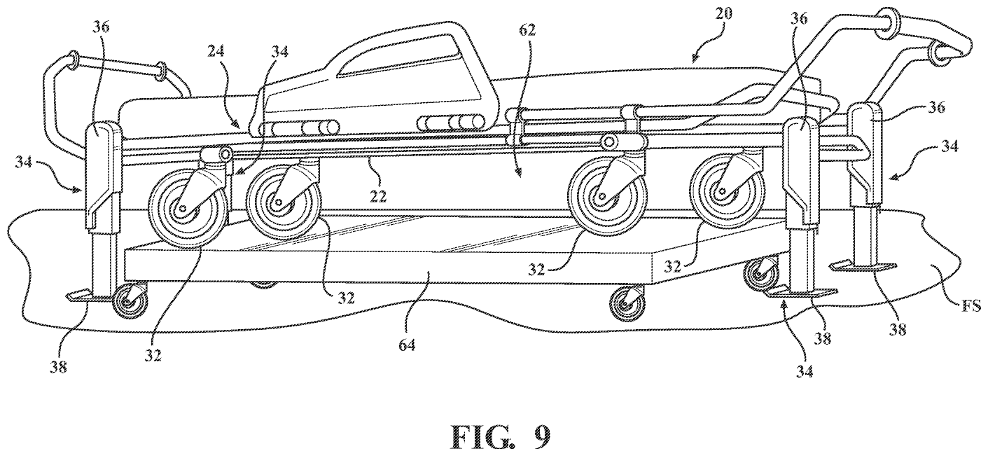

Referring to FIGS. 8 and 9, in some configurations, where the patient transport apparatus 20 is in the lifted configuration, an access area 62 may defined between the plurality of wheels 32 and the floor surface FS that is shaped to receive an auxiliary transport device 64. The auxiliary transport device 64 may include, but is not limited to, another cot, hospital bed, stretcher, table, wheelchair, chair, or similar apparatus utilized in the transportation and care of a bariatric patient. In this example, the jack(s) 34 may be used to lift the patient transport apparatus 20 onto the auxiliary transport device 64. For example, as shown in FIG. 9, after the auxiliary transport device 64 has been position underneath the litter frame 22 and the plurality of wheels 32, the jack(s) 34 may be configured to move the litter frame 22 and the plurality of wheels 32 from the lifted configuration to the spaced configuration such that the plurality of wheels 32 rest on the auxiliary transport device 64.

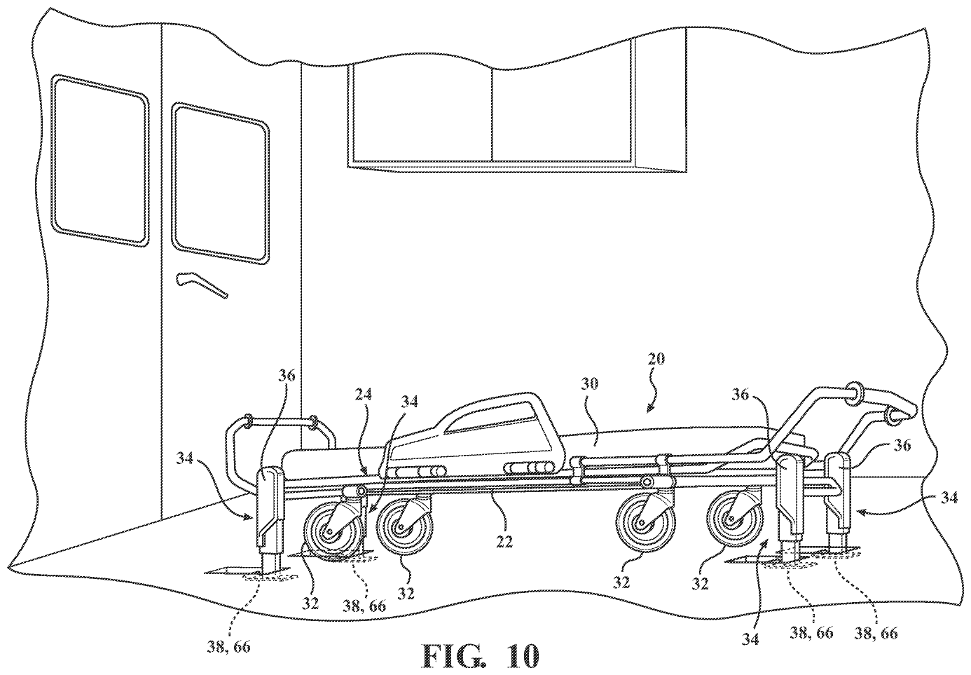

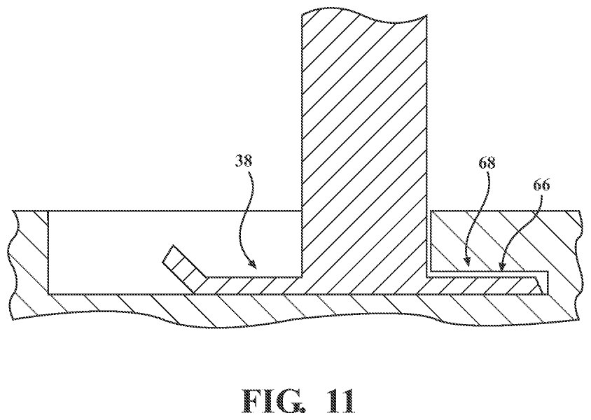

Referring to FIGS. 10 and 11, in some examples, each foot 38 may include a locking feature 66 for engaging a corresponding locking feature 68 on an ambulance floor 70 for constraining the patient transport apparatus 20 relative to the ambulance floor. This is particularly important for constraining the patient transport apparatus 20 relative to the ambulance floor in the event of a crash. A variety of locking feature 66 and corresponding locking feature 68 configurations are contemplated. In the illustrated example, the locking feature 66 is realized as a flange defined by the foot 38, and the corresponding locking feature 68 is realized as a slot defined by the ambulance floor. Of course, other configurations are contemplated. It is also contemplated that the locking feature may be used in addition to or instead of other known restraining devices, such as “antler” fasteners for constraining the patient transport apparatus 20 relative to the ambulance floor.

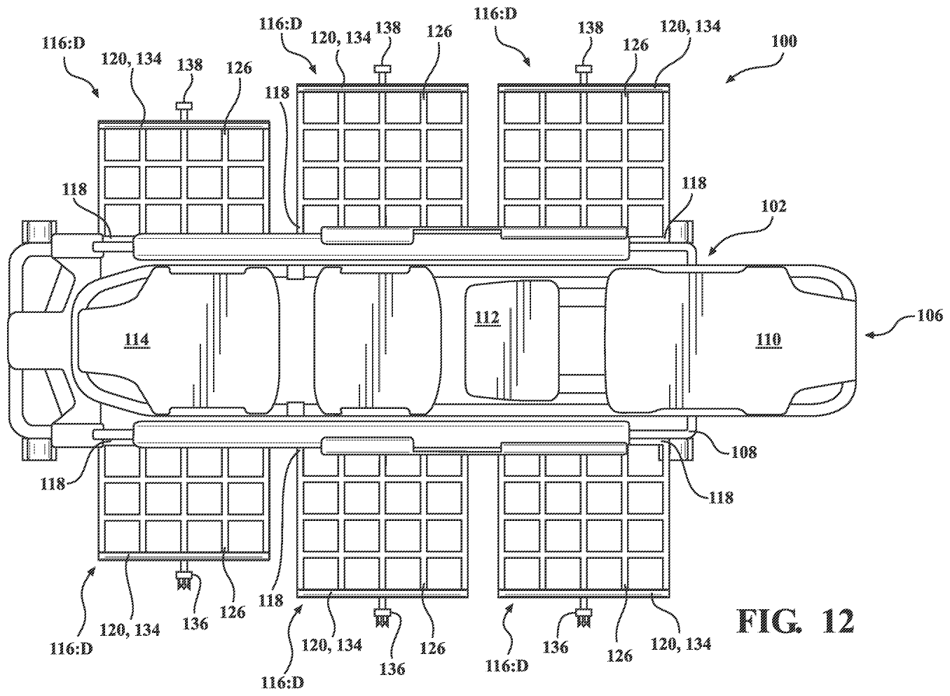

Referring to FIGS. 12-17B, the present disclosure is also directed to a patient transport system 100 for use with a bariatric patient. The patient transport system 100 includes a patient transport apparatus 102 and a plurality of flexible caregiver interfaces 116 operatively attached to the patient transport apparatus 102 and arranged for respective use by a plurality of caregivers applying lifting force to lift the patient transport apparatus 102 and the bariatric patient.

Here, the patient transport apparatus 102 may include a cot, hospital bed, stretcher, table, wheelchair, chair, or similar apparatus utilized in the transportation and care of a bariatric patient. Of course, it should be appreciated that the patient transport apparatus 102 may be utilized in the transportation and care of non-bariatric patients as well. The patient transport apparatus 102 includes a support structure 104 including a patient support deck 106 for supporting the bariatric patient. The support structure 104 may have various configurations and may include a variety of components. In one example, the support structure 104 may configured similar to that of the patient transport apparatus 20 described above. In another example, the support structure 104 may include a litter frame 108 including a patient support deck 106 for supporting the bariatric patient, a base including a plurality of wheels for supporting movement of the patient transport apparatus over a floor surface, and a lift mechanism extending between the litter frame and the base to effect relative movement between the litter frame and the base between a plurality of lift configurations. The lift mechanism can be like that shown in the U.S. Pat. No. 10,987,268 entitled “Emergency Cot With A Litter Height Adjustment Mechanism,” the disclosure of which is hereby incorporated by reference in its entirety.

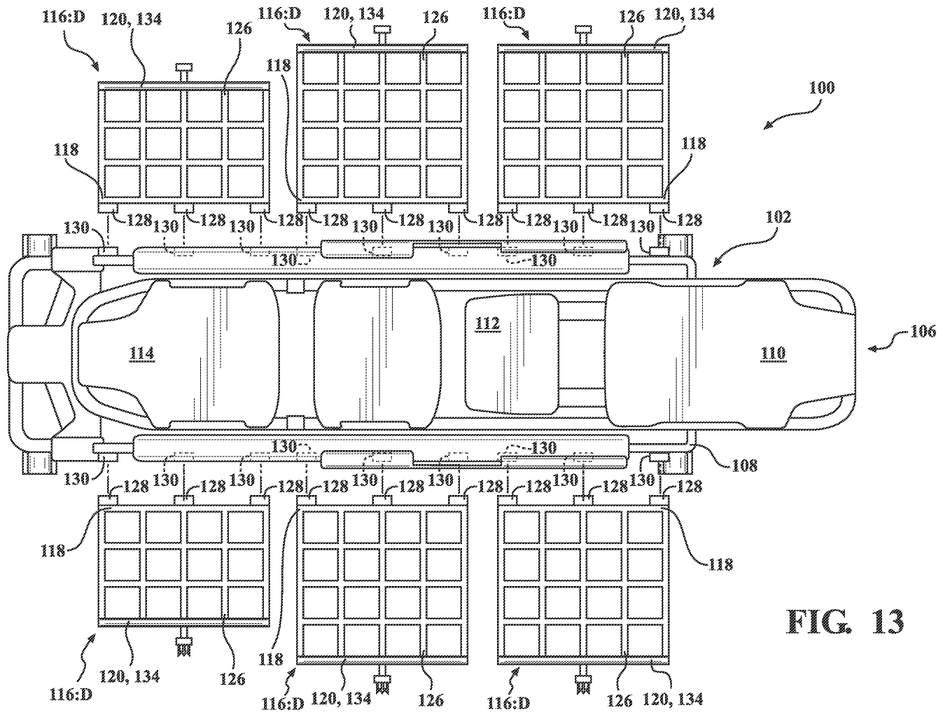

The support structure 104 of the patient transport apparatus 102 may also include a plurality of caster wheel assemblies operatively connected adjacent to each corner of the base. The wheel assemblies may be configured to swivel to facilitate turning of the patient transport apparatus 102. The wheel assemblies may include a swivel locking mechanism to prevent the wheel assemblies from swiveling when engaged. The wheel assemblies may also include wheel brakes to prevent rotation of the wheel. In yet another example, the support structure 104 can be like that shown in like that shown in U.S. Pat. No. 10,987,268 entitled “Emergency Cot With A Litter Height Adjustment Mechanism,” previously referenced. As shown in FIGS. 12 and 13, the patient support deck 106 may be defined by one or more articulable deck sections, for example, a back section 110, a seat section 112, and a foot section 114, to facilitate care and/or transportation of the patient in various patient positions.

The patient transport system 100 also includes a plurality of flexible caregiver interfaces 116 arranged for respective use by a plurality of caregivers 124. As shown in FIGS. 12 and 13, each of the plurality of flexible caregiver interfaces 116 includes a coupling end 118 operatively attached to the support structure 104 of the patient transport apparatus 102 and an interface end 120.

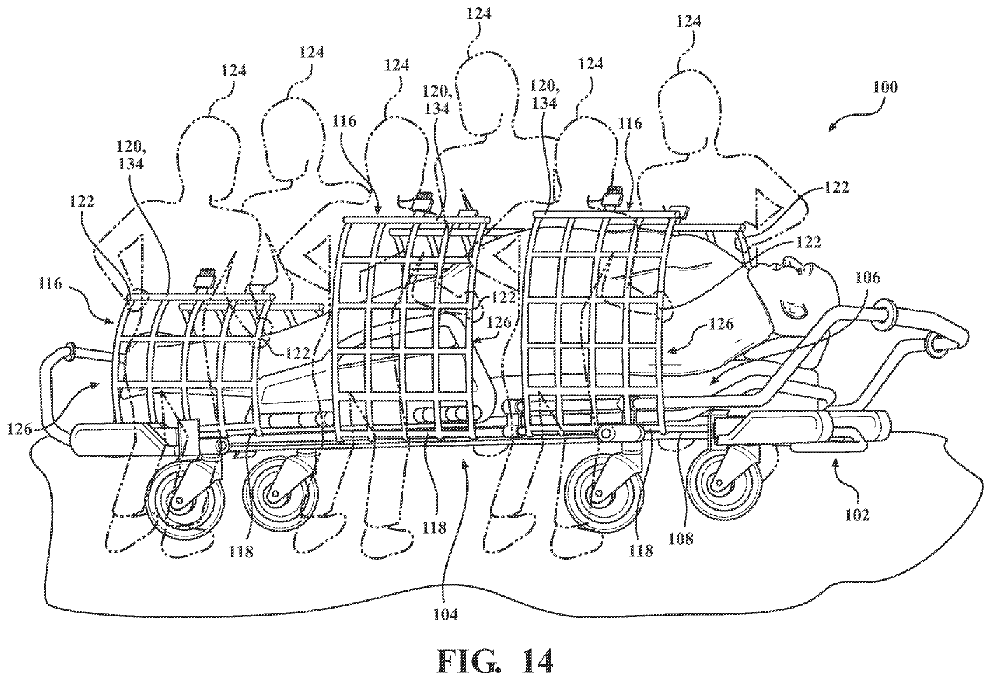

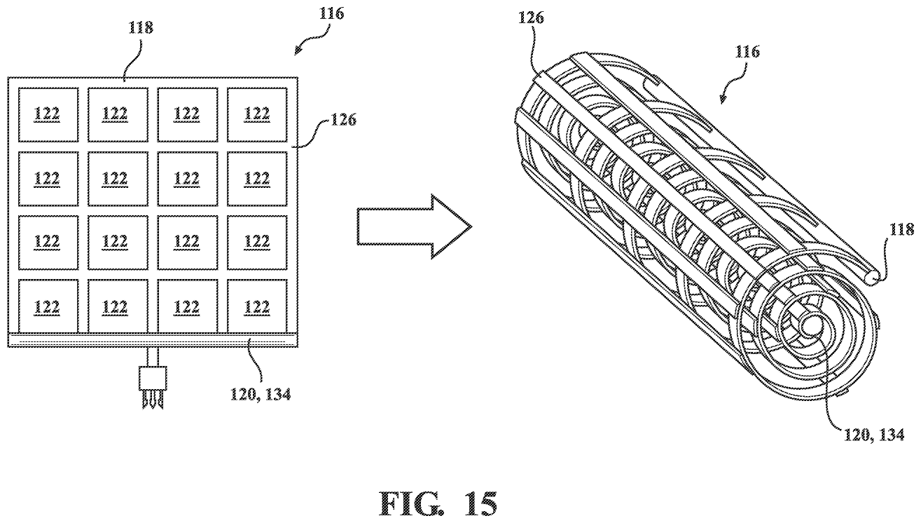

Referring to FIG. 14, the plurality of flexible caregiver interfaces 116 each define a respective plurality of grab points 122 (best shown in FIGS. 14 and 15) arranged to be grasped by one of the plurality of caregivers 124 positioned around lateral sides of the patient transport apparatus 102 for applying lifting force to lift the patient transport apparatus 102 and the bariatric patient. In the examples illustrated in FIGS. 12-14, three flexible caregiver interfaces 116 are attached to each lateral side of the patient transport apparatus 102 for a total of six flexible caregiver interfaces 116. Accordingly, in these examples, six caregivers 124 may position themselves to grab a grab point 122 of a respective flexible caregiver interface 116 to each apply a lifting force to lift the patient transport apparatus 102 and the bariatric patient, as shown in FIG. 14. Of course, it is contemplated that more or less flexible caregiver interfaces 116 may be attached to the patient transport apparatus and more or less caregivers 124 may engage the flexible caregiver interfaces 116 to apply lifting force to lift the patient transport apparatus 102 and the bariatric patient.

As shown in FIGS. 12-17B, the each of the flexible caregiver interfaces 116 may include a net 126 comprised of webbing and extending between the coupling end 118 and the interface end 120. The webbing may comprise polyester, nylon, polypropylene, cotton, elastic, and the like. The webbing may also be a coated webbing, such as a polyurethane-coated webbing as disclosed in U.S. Pat. No. 10,080,693 entitled “Harness System For Patient Transport Apparatus,” the disclosure of which is hereby incorporated by reference in its entirety. In the illustrated example, the net 126 defines the respective plurality of grab points 122 arranged to be grasped by one of the plurality of caregivers 124 positioned around lateral sides of the patient transport apparatus 102 for applying lifting force to lift the patient transport apparatus 102 and the bariatric patient. Advantageously, the numerous voids of the net 126 provides a large number of grab points 122. Of course, other configurations the flexible caregiver interfaces 116 are contemplated, such as ropes, straps, cables, and the like.

The coupling end 118 of each of the flexible caregiver interfaces 116 may be coupled to any component of the support structure 104 of the patient transport apparatus 102 that is configured to withstand the load of the lifting force applied to each of the flexible caregiver interfaces 116. For example, the coupling end 118 of each of the flexible caregiver interfaces 116 may be coupled to one of the litter frame 108, the patient support deck 106, and the base of the transport apparatus (where included). It is also contemplated that some of the flexible caregiver interfaces 116 may be coupled to different components of the patient transport apparatus 102 than other flexible caregiver interfaces 116. For example, one or more of the flexible caregiver interfaces 116 may be coupled to one component of the patient transport apparatus 102 (e.g., the litter frame 108) and one or more of the flexible caregiver interfaces 116 may be coupled to another component of the patient transport apparatus 102 (e.g., the patient support deck 106).

Referring to FIG. 13, the coupling end 118 of each of the flexible caregiver interfaces 116 may be removably coupled to the support structure 104 of the patient transport apparatus 102. For example, the coupling end 118 of each flexible caregiver interface 116 may include one or more fasteners 128 configured to removably engage corresponding fasteners 130 disposed on the support structure 104 of the patient transport apparatus 102 to removably couple each flexible caregiver interface 116 to the support structure 104. The one or more fasteners 128 coupled to the flexible caregiver interface 116 and one or more corresponding fasteners 130 coupled to the support structure 104 should be configured to cooperate with each other to removably couple the coupling end 118 of each of the flexible caregiver interfaces 116 to the support structure 104 in a manner that withstands the load of the lifting force applied by the caregivers 124 to each of the flexible caregiver interfaces 116. For example, the one or more fasteners 128 coupled to the flexible caregiver interface 116 and one or more corresponding fasteners 130 coupled to the support structure 104 may be realized as cooperating structures of magnets, carabiners, snap buttons, toggle clamps, ball and detent mechanisms, cam latches, ratchet strap mechanisms, rope cleats, thumb screws, and the like. Additionally, the one or more fasteners 128 may also be configured to removably engage corresponding fasteners disposed on an ambulance floor for constraining the patient transport apparatus 102 and/or the bariatric patient disposed on the patient transport apparatus 102 relative to the ambulance floor (not shown).

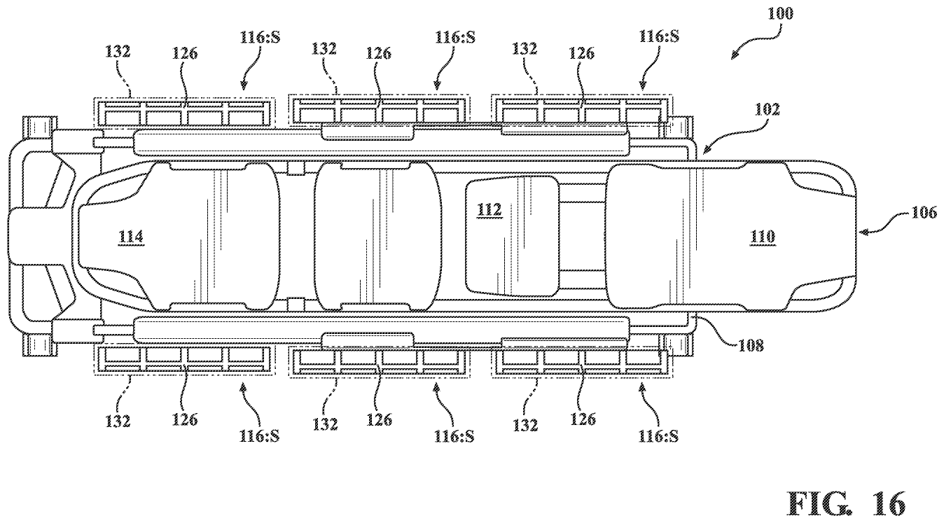

Each of the plurality of flexible caregiver interfaces 116 are configured for movement between a stowed configuration 116S and a deployed configuration 116D. FIGS. 12-14 show the plurality of flexible caregiver interfaces 116 in the deployed configuration 116D. In the deployed configuration 116D, the interface end 120 of the flexible caregiver interface 116 is spaced from the support structure 104 to arrange the plurality of grab points 122 for engagement by one of the respective plurality of caregivers 124 for applying lifting force to lift the patient transport apparatus 102 and the bariatric patient. FIG. 16 best shows the plurality of flexible caregiver interfaces 116 in the stowed configuration 116S. In the stowed configuration 116S, the interface end 120 of the flexible caregiver interface 116 is secured adjacent to the support structure 104 to store the flexible caregiver interface 116 when it is not in use.

The patient transport system 100 may also include a plurality of containers 132 operatively attached to the support structure 104 of the patient transport apparatus 102. Each container 132 may be configured to receive one or more of the plurality of flexible caregiver interfaces 116 in the stowed configuration 116S to store the flexible caregiver interface 116 when it is not in use. The containers 132 may be a soft container (such as a pouch) or a hard container (such as a box).

Referring to FIG. 15, each flexible caregiver interface 116 may further include a frame member 134 extending along the interface end 120 of the net 126. Where the flexible caregiver interface 116 is in the deployed configuration 116D, the frame member 134 provides the advantage of inhibiting the net 126 from buckling along the interface end 120, thereby allowing the net 126 to remain expanded to allow a caregiver 124 to easily grasp one of the grab points 122. With continued reference to FIG. 15, where the flexible caregiver interface 116 is in the stowed configuration 116S, the net 126 may be configured to be wrapped around the frame member 134 to move the flexible caregiver interface 116 to the stowed configuration 116S.

Additionally, in some examples, the interface end 120 of each net 126 may also be configured to removably engage an auxiliary transport device in the deployed configuration 116D to facilitate lateral transfer of the bariatric patient from the patient transport apparatus 102 to the auxiliary transport device. The auxiliary transport device may include, but is not limited to, another cot, hospital bed, stretcher, table, wheelchair, chair, ambulance, or similar apparatus utilized in the transportation and care of a bariatric patient.

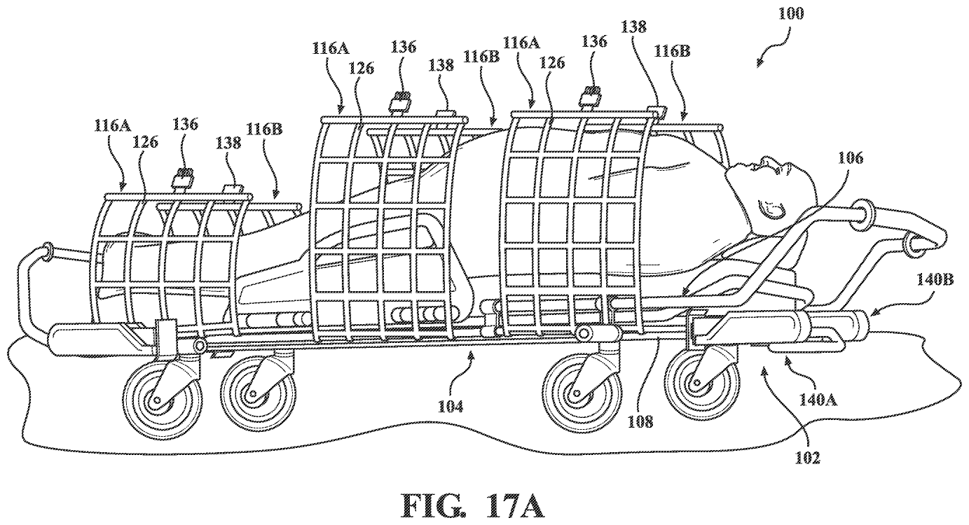

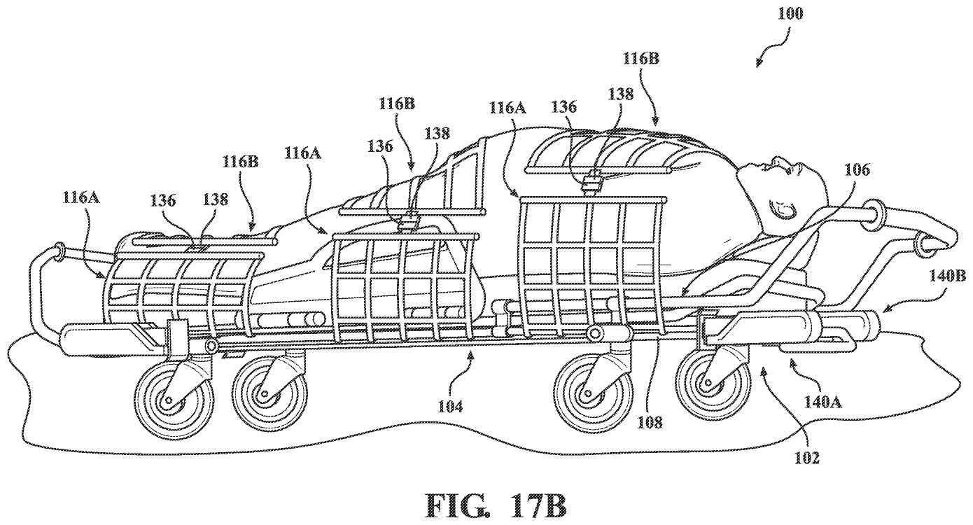

Referring now to FIGS. 17A and 17B, in some examples, each of the plurality of flexible caregiver interfaces 116 may be configured to extend around the bariatric patient such that each of the plurality of flexible caregiver interface 116 are configured to engage the bariatric patient to locate and secure the bariatric patient relative to the patient support deck 106. To locate and secure the bariatric patient relative to the patient support deck 106 each of the plurality of flexible caregiver interfaces 116 may further include a coupler 136 operatively attached to the interface end 120. Each coupler 136 may be configured to engage a corresponding receiver 138 operatively attached to the support structure 104 of the patient transport apparatus 102 such that each of the plurality of flexible caregiver interfaces 116 is configured to engage the bariatric patient to locate and secure the bariatric patient relative to the patient support deck 106. A variety of configurations of the coupler 136 and corresponding receiver 138 are contemplated such as a buckle and receiver, a carabiner and a metallic D-ring, and the like.

In some examples, the corresponding receiver 138 may be disposed on an opposite lateral side of the support structure as its respective flexible caregiver interface 116. In other examples such as shown in FIGS. 17A and 17B, the plurality of flexible caregiver interfaces 116 may include one or more first flexible caregiver interfaces 116A arranged on a first lateral side 140A of the patient transport apparatus 102 and one or more second flexible caregiver interfaces 116B arranged on a second lateral side 140B of the patient transport apparatus, opposite the first lateral side 140A. In these examples, the first flexible caregiver interfaces 116A may each include a coupler 136 operatively attached to the interface end 120 of the respective first flexible caregiver interface 116A. The coupler 136 may be configured to engage a corresponding receiver 138 operatively attached to a respective interface end 120 of each of the second flexible caregiver interfaces 116B such that the first flexible caregiver interfaces 116A and the second flexible caregiver interfaces 116B are configured to collectively extend around bariatric patient and engage the bariatric patient to locate and secure the bariatric patient relative to the patient support deck 106, as shown in FIG. 17B.

It will be further appreciated that the terms “include,” “includes,” and “including” have the same meaning as the terms “comprise,” “comprises,” and “comprising.” Moreover, it will be appreciated that terms such as “first,” “second,” “third,” and the like are used herein to differentiate certain structural features and components for the non-limiting, illustrative purposes of clarity and consistency.

Several configurations have been discussed in the foregoing description. However, the configurations discussed herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

The present disclosure also comprises the following clauses, with specific features laid out in dependent clauses, that may specifically be implemented as described in greater detail with reference to the configurations and drawings above.

### CLAUSES

I. A patient transport apparatus for use with a patient, the patient transport apparatus comprising:
a litter frame including a patient support deck for supporting the patient, the litter frame defining a longitudinal axis extending between a head end and a foot end and a lateral axis transverse to the longitudinal axis;
a plurality of wheels coupled to the litter frame for supporting movement of the patient transport apparatus over a floor surface; and
at least three jacks coupled to the litter frame to move the litter frame and the plurality of wheels between a plurality of vertical configurations relative to the floor surface, each of the at least three jacks including a mounting portion coupled to the litter frame, and a foot operatively attached to the mounting portion and configured for movement relative to the mounting portion to provide a respective contact point with the floor surface;
wherein at least one of the at least three jacks is arranged between the head end and the lateral axis, at least one of the at least three jacks is arranged between the foot end and the lateral axis, at least one of the at least three jacks is arranged on a first lateral side of the longitudinal axis, and at least one of the at least three jacks is arranged on a second lateral side of the longitudinal axis, opposite the first lateral side.
II. The patient transport apparatus of clause I, wherein each foot of the at least three jacks is configured for independent movement relative to its respective mounting portion to provide the respective contact point.
III. The patient transport apparatus of clause II, wherein each of the at least three jacks further includes a motor operatively attached to the foot for moving the foot relative to the mounting portion to move the litter frame and the plurality of wheels between the plurality of vertical configurations relative to the floor surface.
IV. The patient transport apparatus of clause III, further comprising a level sensor operatively attached to the litter frame and configured to generate a level signal pertaining to the orientation of the litter frame, and a controller in communication with the level sensor and each motor of the at least three jacks, the controller configured to operate each motor of the at least three jacks to level the litter frame relative to the floor surface.
V. The patient transport apparatus of clause II, wherein each of the at least three jacks further include a manual actuator operatively attached to the foot for moving the foot relative to the mounting portion to move the litter frame and the plurality of wheels between the plurality of vertical configurations relative to the floor surface.
VI. The patient transport apparatus of clause II, further comprising a hydraulic circuit having a pump driven by a motor; and
wherein each of the at least three jacks further includes a hydraulic actuator disposed in fluid communication with the hydraulic circuit and operatively attached to the foot for moving the foot relative to the mounting portion to move the litter frame and the plurality of wheels between the plurality of vertical configurations relative to the floor surface.
VII. The patient transport apparatus of any of clauses I-VI, wherein the mounting portion of each of the at least three jacks is a housing, and each of the at least three jacks further includes a post disposed in the housing for movement relative to the housing, the post extending between a top end and a bottom end, wherein each foot is coupled to the bottom end of the respective post.
VIII. The patient transport apparatus of clause VII, wherein the mounting portion of each of the at least three jacks is pivotably coupled to the litter frame such that each of the at least three jacks are configured for pivotal movement relative to the litter frame between a plurality of jack configurations.
IX. The patient transport apparatus of clause VIII, wherein the plurality of jack configurations includes a stored configuration where the respective post is parallel with the litter frame.
X. The patient transport apparatus of any of clauses VIII-IX, wherein the plurality of jack configurations includes a deployed configuration where the respective post is arranged extending toward the floor surface such that each foot is configured to move relative to the housing to provide a respective contact point with the floor surface.
XI. The patient transport apparatus of any of clauses VIII-X, wherein the plurality of jack configurations includes a handle configuration where the respective post is arranged extending away from the floor surface such that the respective post provides a grab point arranged for engagement by a caregiver to maneuver the patient transport apparatus across the floor surface.
XII. The patient transport apparatus of any of clauses VII-XI, wherein each of the at least three jacks further includes a motor operatively attached to the post for moving the post and the foot relative to the housing to move the litter frame and the plurality of wheels between the plurality of vertical configurations relative to the floor surface.
XIII. The patient transport apparatus of clause XII, wherein each motor of the at least three jacks are independently controllable to move each foot independently to provide the respective contact point.
XIV. The patient transport apparatus of any of clauses I-XIII, wherein the plurality of vertical configurations includes a spaced configuration where each foot of the at least three jacks are spaced out of contact with the floor surface such that the plurality of wheels support movement of the patient transport apparatus over the floor surface.
XV. The patient transport apparatus of clause XIV, wherein the plurality of vertical configurations includes a stabilization configuration where the plurality of wheels remain in contact with the floor surface and each foot of the at least three jacks contacts the floor surface to provide additional stability to the patient transport apparatus.
XVI. The patient transport apparatus of any of clauses XIV-XV, wherein the plurality of vertical configurations includes a lifted configuration where each foot of the at least three jacks are moved away from the litter frame such that the plurality of wheels are spaced out of contact with the floor surface and the at least three jacks support the patient transport apparatus relative to the floor surface.
XVII. The patient transport apparatus of clause XVI, wherein an access area is defined during operation in the lifted configuration between the plurality of wheels and the floor surface shaped to receive an auxiliary transport device.
XVIII. The patient transport apparatus of clause XVII, wherein the at least three jacks are configured to move the litter frame and the plurality of wheels from the lifted configuration to the spaced configuration such that the plurality of wheels rest on the auxiliary transport device.
XIX. The patient transport apparatus of any of clauses I-XVIII, wherein each foot includes a locking feature for engaging a corresponding locking feature on an ambulance floor for constraining the patient transport apparatus relative to the ambulance floor.
XX. The patient transport apparatus of any of clauses I-XIX, further comprising a plurality of flexible caregiver interfaces arranged for respective use by a plurality of caregivers, each of the plurality of flexible caregiver interfaces including a coupling end operatively attached to the litter frame and an interface end, the plurality of flexible caregiver interfaces each defining a respective plurality of grab points arranged to be grasped by one of the plurality of caregivers positioned around lateral sides of the patient transport apparatus for applying lifting force to lift the patient transport apparatus and the patient.
XXI. The patient transport apparatus of clause XX, wherein each of the plurality of flexible caregiver interfaces are configured for movement between:
a stowed configuration where the interface end of the flexible caregiver interface is secured adjacent to the litter frame, and
a deployed configuration where the interface end of the flexible caregiver interface is spaced from the litter frame to arrange the plurality of grab points for engagement by one of the respective plurality of caregivers for applying lifting force to lift the patient transport apparatus and the patient.
XXII. A patient transport apparatus for use with a patient, the patient transport apparatus comprising:
a litter frame including a patient support deck for supporting the patient;
a plurality of wheels coupled to the litter frame for supporting movement of the patient transport apparatus over a floor surface; and
at least one jack coupled to the litter frame to move the litter frame and the plurality of wheels between a plurality of vertical configurations relative to the floor surface, each jack including a mounting portion coupled to the litter frame, and a foot operatively attached to the mounting portion and configured for movement relative to the mounting portion to provide a respective contact point with the floor surface;
wherein the plurality of vertical configurations includes a lifted configuration where the foot of each jack is moved away from the litter frame such that the plurality of wheels are spaced out of contact with the floor surface and the at least one jack supports the patient transport apparatus relative to the floor surface.
XXIII. The patient transport apparatus of clause XXII, wherein the at least one jack includes at least three jacks.
XXIV. The patient transport apparatus of clause XXIII, wherein the litter frame defines a longitudinal axis extending between a head end and a foot end and a lateral axis transverse to the longitudinal axis; and
wherein at least one of the at least three jacks is arranged between the head end and the lateral axis, at least one of the at least three jacks is arranged between the foot end and the lateral axis, at least one of the at least three jacks is arranged on a first lateral side of the longitudinal axis, and at least one of the at least three jacks is arranged on a second lateral side of the longitudinal axis, opposite the first lateral side.
XXV. The patient transport apparatus of any of clauses XXII-XXIV, wherein the plurality of vertical configurations further includes a spaced configuration where the foot of each jack is spaced out of contact with the floor surface such that the plurality of wheels support movement of the patient transport apparatus over the floor surface.
XXVI. The patient transport apparatus of any of clauses XXII-XXV, wherein the plurality of vertical configurations further includes a stabilization configuration where the plurality of wheels remain in contact with the floor surface and the foot of each jack contacts the floor surface to provide additional stability to the patient transport apparatus.
XXVII. The patient transport apparatus of any of clauses XXII-XXVI, wherein each jack further includes a motor operatively attached to the foot for moving the foot relative to the mounting portion to move the litter frame and the plurality of wheels between the plurality of vertical configurations relative to the floor surface.
XXVIII. The patient transport apparatus of any of clauses XXII-XXVI, wherein each jack further includes a manual actuator operatively attached to the foot for moving the foot relative to the mounting portion to move the litter frame and the plurality of wheels between the plurality of vertical configurations relative to the floor surface.
XXIX. The patient transport apparatus of any of clauses XXII-XXVI, further comprising a hydraulic circuit having a pump driven by a motor; and wherein each jack further includes a hydraulic actuator disposed in fluid communication with the hydraulic circuit and operatively attached to the foot for moving the foot relative to the mounting portion to move the litter frame and the plurality of wheels between the plurality of vertical configurations relative to the floor surface.
XXX. The patient transport apparatus of any of clauses XXII-XXIX, wherein the mounting portion of each jack is pivotably coupled to the litter frame such that each jack is configured for pivotal movement relative to the litter frame between a plurality of jack configurations.
XXXI. The patient transport apparatus of any of clauses XXII-XXX, further comprising a plurality of flexible caregiver interfaces arranged for respective use by a plurality of caregivers, each of the plurality of flexible caregiver interfaces including a coupling end operatively attached to the litter frame and an interface end, the plurality of flexible caregiver interfaces each defining a respective plurality of grab points arranged to be grasped by one of the plurality of caregivers positioned around lateral sides of the patient transport apparatus for applying lifting force to lift the patient transport apparatus and the patient.
XXXII. The patient transport apparatus of clause XXXI, wherein each of the plurality of flexible caregiver interfaces are configured for movement between:
a stowed configuration where the interface end of the flexible caregiver interface is secured adjacent to the litter frame, and
a deployed configuration where the interface end of the flexible caregiver interface is spaced from the litter frame to arrange the plurality of grab points for engagement by one of the respective plurality of caregivers for applying lifting force to lift the patient transport apparatus and the patient.
XXXIII. A patient transport system for use with a patient, the patient transport system comprising:
a patient transport apparatus including a support structure including a patient support deck for supporting the patient; and
a plurality of flexible caregiver interfaces arranged for respective use by a plurality of caregivers, each of the plurality of flexible caregiver interfaces including a coupling end operatively attached to the support structure and an interface end, the plurality of flexible caregiver interfaces each defining a respective plurality of grab points arranged to be grasped by one of the plurality of caregivers positioned around lateral sides of the patient transport apparatus for applying lifting force to lift the patient transport apparatus and the patient,
wherein each of the plurality of flexible caregiver interfaces are configured for movement between:
   a stowed configuration where the interface end of the flexible caregiver interface is secured adjacent to the support structure, and
   a deployed configuration where the interface end of the flexible caregiver interface is spaced from the support structure to arrange the plurality of grab points for engagement by one of the respective plurality of caregivers for applying lifting force to lift the patient transport apparatus and the patient.
XXXIV. The patient transport system of clause XXXIII, wherein the coupling end of each flexible caregiver interface is removably coupled to the support structure.
XXXV. The patient transport system of clause XXXIV, wherein the coupling end of each flexible caregiver interface includes one or more fasteners configured to removably engage corresponding fasteners disposed on the support structure to removably couple each flexible caregiver interface to the support structure.
XXXVI. The patient transport system of clause XXXV, wherein the one or more fasteners are magnetic.
XXXVII. The patient transport system of clause XXXV, wherein the one or more fasteners are also configured to removably engage corresponding fasteners disposed on an ambulance floor for constraining the patient transport apparatus and the patient relative to the ambulance floor.
XXXVIII. The patient transport system of any of clauses XXXIII-XXXVII, further comprising a plurality of containers operatively attached to the support structure of the patient transport apparatus, each container configured to receive one of the plurality of flexible caregiver interfaces in the stowed configuration.
XXXIX. The patient transport system of any of clauses XXXIII-XXXVIII, wherein each of the flexible caregiver interfaces includes a net comprised of webbing and extending between the coupling end and the interface end, the net defining the respective plurality of grab points arranged to be grasped by one of the plurality of caregivers positioned around lateral sides of the patient transport apparatus for applying lifting force to lift the patient transport apparatus and the patient.
XL. The patient transport system of clause XXXIX, wherein the webbing is coated.
XLI. The patient transport system of any of clauses XXXIX-XL, wherein the interface end of each net is also configured to removably engage an auxiliary transport device in the deployed configuration to facilitate lateral transfer of the patient from the patient transport apparatus to the auxiliary transport device.
XLII. The patient transport system of any of clauses XXXIX-XLI, wherein each flexible caregiver interface further includes a frame member extending along the interface end of the net to inhibit the net from buckling along the interface end.
XLIII. The patient transport system of clause XLII, wherein the net is configured to be wrapped around the frame member to move the flexible caregiver interface to the stowed configuration.
XLIV. The patient transport system of any of clauses XXXIII-XLIII, wherein each of the plurality of flexible caregiver interfaces are configured to extend around the patient such that each of the plurality of flexible caregiver interface is configured to engage the patient to locate and secure the patient relative to the patient support deck.
XLV. The patient transport system of clause XLIV, wherein each of the plurality of flexible caregiver interfaces further includes a coupler operatively attached to the interface end; and
wherein each coupler is configured to engage a corresponding receiver operatively attached to the support structure of the patient transport apparatus such that each of the plurality of flexible caregiver interface is configured to engage the patient to locate and secure the patient relative to the patient support deck.
XLVI. The patient transport system of any of clauses XXXIII-XLV, wherein the plurality of flexible caregiver interfaces includes a first flexible caregiver interface arranged on a first lateral side of the patient transport apparatus and a second flexible caregiver interface arranged on a second lateral side of the patient transport apparatus, opposite the first lateral side.
XLVII. The patient transport system of clause XLVI, wherein the first flexible caregiver interface further includes a coupler operatively attached to the interface end of the first flexible caregiver interface, the coupler configured to engage a corresponding receiver operatively attached to the interface end of the second flexible caregiver interface such that the first flexible caregiver interface and the second flexible caregiver interface are configured to collectively extend around patient and engage the patient to locate and secure the patient relative to the patient support deck.
XLVIII. The patient transport system of any of clauses XXXIII-XLVIII, wherein the support structure of the patient transport apparatus includes:
a litter frame including a patient support deck for supporting the patient;
a base including a plurality of wheels for supporting movement of the patient transport apparatus over a floor surface; and
a lift mechanism extending between the litter frame and the base to effect relative movement between the litter frame and the base between a plurality of lift configurations.
XLIX. The patient transport system of clause XLVIII, wherein each coupling end of the plurality of flexible caregiver interfaces is coupled to one of the litter frame, the base, and the patient support deck.

What is claimed is:

1. A patient transport apparatus for use with a patient, the patient transport apparatus comprising:
a litter frame including a patient support deck for supporting the patient;
a plurality of wheels coupled to the litter frame for supporting movement of the patient transport apparatus over a floor surface; and
at least one jack coupled to the litter frame to move the litter frame and the plurality of wheels between a plurality of vertical configurations relative to the floor surface, each jack including a mounting portion coupled to the litter frame, and a foot operatively attached to the mounting portion and configured for movement relative to the mounting portion to provide a respective contact point with the floor surface;
wherein the plurality of vertical configurations includes a lifted configuration where the foot of each jack is moved away from the litter frame such that the plurality of wheels are spaced out of contact with the floor surface and the at least one jack supports the patient transport apparatus relative to the floor surface.

2. The patient transport apparatus of claim 1, wherein the at least one jack includes at least three jacks; and
wherein the litter frame defines a longitudinal axis extending between a head end and a foot end and a lateral axis transverse to the longitudinal axis; and
wherein at least one of the at least three jacks is arranged between the head end and the lateral axis, at least one of the at least three jacks is arranged between the foot end and the lateral axis, at least one of the at least three jacks is arranged on a first lateral side of the longitudinal axis, and at least one of the at least three jacks is arranged on a second lateral side of the longitudinal axis, opposite the first lateral side.

3. The patient transport apparatus of claim 1, wherein the plurality of vertical configurations further includes a spaced configuration where the foot of each jack is spaced out of contact with the floor surface such that the plurality of wheels support movement of the patient transport apparatus over the floor surface.

4. The patient transport apparatus of claim 1, wherein the plurality of vertical configurations further includes a stabilization configuration where the plurality of wheels remain in contact with the floor surface and the foot of each jack contacts the floor surface to provide additional stability to the patient transport apparatus.

5. The patient transport apparatus of claim 1, wherein each jack further includes a motor operatively attached to the foot for moving the foot relative to the mounting portion to move the litter frame and the plurality of wheels between the plurality of vertical configurations relative to the floor surface.

6. The patient transport apparatus of claim 1, wherein each jack further includes a manual actuator operatively attached to the foot for moving the foot relative to the mounting portion to move the litter frame and the plurality of wheels between the plurality of vertical configurations relative to the floor surface.

7. The patient transport apparatus of claim 1, further comprising a hydraulic circuit having a pump driven by a motor; and
wherein each jack further includes a hydraulic actuator disposed in fluid communication with the hydraulic circuit and operatively attached to the foot for moving the foot relative to the mounting portion to move the litter frame and the plurality of wheels between the plurality of vertical configurations relative to the floor surface.

8. The patient transport apparatus of claim 1, wherein the mounting portion of each jack is pivotably coupled to the litter frame such that each jack is configured for pivotal movement relative to the litter frame between a plurality of jack configurations.

9. The patient transport apparatus of claim 1, further comprising a plurality of flexible caregiver interfaces arranged for respective use by a plurality of caregivers, each of the plurality of flexible caregiver interfaces including a coupling end operatively attached to the litter frame and an interface end, the plurality of flexible caregiver interfaces each defining a respective plurality of grab points arranged to be grasped by one of the plurality of caregivers positioned around lateral sides of the patient transport apparatus for applying lifting force to lift the patient transport apparatus and the patient.

10. The patient transport apparatus of claim 9, wherein each of the plurality of flexible caregiver interfaces are configured for movement between:
a stowed configuration where the interface end of the flexible caregiver interface is secured adjacent to the litter frame, and
a deployed configuration where the interface end of the flexible caregiver interface is spaced from the litter frame to arrange the plurality of grab points for engagement by one of the respective plurality of caregivers for applying lifting force to lift the patient transport apparatus and the patient.

11. A patient transport system for use with a patient, the patient transport system comprising:
a patient transport apparatus including a support structure including a patient support deck for supporting the patient; and
a plurality of flexible caregiver interfaces arranged for respective use by a plurality of caregivers, each of the plurality of flexible caregiver interfaces including a coupling end operatively attached to the support structure and an interface end, the plurality of flexible caregiver interfaces each defining a respective plurality of grab points arranged to be grasped by one of the plurality of caregivers positioned around lateral sides of the patient transport apparatus for applying lifting force to lift the patient transport apparatus and the patient,
wherein each of the plurality of flexible caregiver interfaces are configured for movement between:
a stowed configuration where the interface end of the flexible caregiver interface is secured adjacent to the support structure, and
a deployed configuration where the interface end of the flexible caregiver interface is spaced from the support structure to arrange the plurality of grab points for engagement by one of the respective plurality of caregivers for applying lifting force to lift the patient transport apparatus and the patient.

12. The patient transport system of claim 11, wherein the coupling end of each flexible caregiver interface is removably coupled to the support structure.

13. The patient transport system of claim 12, wherein the coupling end of each flexible caregiver interface includes one or more fasteners configured to removably engage corresponding fasteners disposed on the support structure to removably couple each flexible caregiver interface to the support structure.

14. The patient transport system of claim 13, wherein the one or more fasteners are also configured to removably engage corresponding fasteners disposed on an ambulance floor for constraining the patient transport apparatus and the patient relative to the ambulance floor.

15. The patient transport system of claim 11, further comprising a plurality of containers operatively attached to the support structure of the patient transport apparatus, each container configured to receive one of the plurality of flexible caregiver interfaces in the stowed configuration.

16. The patient transport system of claim 11, wherein each of the flexible caregiver interfaces includes a net comprised of webbing and extending between the coupling end and the interface end, the net defining the respective plurality of grab points arranged to be grasped by one of the plurality of caregivers positioned around lateral sides of the patient transport apparatus for applying lifting force to lift the patient transport apparatus and the patient.

17. The patient transport system of claim 16, wherein each flexible caregiver interface further includes a frame member extending along the interface end of the net to inhibit the net from buckling along the interface end.

18. The patient transport system of claim 17, wherein the net is configured to be wrapped around the frame member to move the flexible caregiver interface to the stowed configuration.

19. The patient transport system of claim 11, wherein each of the plurality of flexible caregiver interfaces are configured to extend around the patient such that each of the plurality of flexible caregiver interface is configured to engage the patient to locate and secure the patient relative to the patient support deck;
wherein each of the plurality of flexible caregiver interfaces further includes a coupler operatively attached to the interface end; and
wherein each coupler is configured to engage a corresponding receiver operatively attached to the support structure of the patient transport apparatus such that each of the plurality of flexible caregiver interface is configured to engage the patient to locate and secure the patient relative to the patient support deck.

20. The patient transport system of claim 11, wherein the plurality of flexible caregiver interfaces includes a first flexible caregiver interface arranged on a first lateral side of the patient transport apparatus and a second flexible caregiver interface arranged on a second lateral side of the patient transport apparatus, opposite the first lateral side; and
wherein the first flexible caregiver interface further includes a coupler operatively attached to the interface end of the first flexible caregiver interface, the coupler configured to engage a corresponding receiver operatively attached to the interface end of the second flexible caregiver interface such that the first flexible caregiver interface and the second flexible caregiver interface are configured to collectively extend around patient and engage the patient to locate and secure the patient relative to the patient support deck.
